(19) United States
(12) Patent Application Publication
(10) Pub. No.: US 2021/0382675 A1
(43) Pub. Date: Dec. 9, 2021

(54) SYSTEM AND METHOD OF ORGANIZING A VIRTUAL CLASSROOM SETTING

(71) Applicant: Tangible Play, Inc., Palo Alto, CA (US)

(72) Inventors: Pramod Kumar Sharma, San Jose, CA (US); Jerome Scholler, San Francisco, CA (US); Tony Aube, Palo Alto, CA (US); Mark Solomon, San Jose, CA (US)

(21) Appl. No.: 17/342,402

(22) Filed: Jun. 8, 2021

Related U.S. Application Data
(60) Provisional application No. 63/036,348, filed on Jun. 8, 2020.

(51) Int. Cl. G06F 3/14; G06F 40/169; G06F 3/0481; G06T 11/00; G09B 5/06

(52) U.S. Cl. CPC G06F 3/1454; G06F 40/169; G09B 19/025; G06T 11/00; G09B 5/065; G06F 3/0481

(57) ABSTRACT

A method and system for organizing a virtual classroom session. In an example implementation, a method includes, receiving first media data including a first user media stream depicting a first user and a first workspace media stream depicting a first physical activity scene that is proximate a first computing device of the first user and a second media data including a second user media stream depicting a second user and a second workspace media stream depicting a second physical activity scene that is proximate a second computing device of the second user, generating a graphical virtual meeting user interface and providing the graphical virtual meeting user interface for display.

### BACKGROUND

The present disclosure relates to a system and method of organizing a virtual classroom settings.

Existing solutions for facilitating virtual classrooms rely on existing video conferencing software. The teacher sends out a video conference invitation to each of the students in the classroom. The teacher uses a computing device, such as a computer with a web camera to share a video stream of the teacher using the web camera as the teacher presents information to the students. The teacher can share this video stream so that the students can join the video conference session. However, these existing video conference sessions are limited in how they allow the students and the teacher to interact. A teacher can share a screen for presentation and the students are only able to share a single video feed as they observe the teacher. These video conference sessions do not imitate an in-person classroom session.

### SUMMARY

According to one innovative aspect of the subject matter in this disclosure, a system and method of organizing a virtual classroom setting is described. In an example implementation the method also includes receiving first media data including a first user media stream depicting a first user and a first workspace media stream depicting a first physical activity scene that is proximate a first computing device of the first user; receiving second media data including a second user media stream depicting a second user and a second workspace media stream depicting a second physical activity scene that is proximate a second computing device of the second user, generating a graphical virtual meeting user interface including: a first content region displaying one or more of the first user media stream depicting the first user and the first workspace media stream depicting the first physical activity scene that is proximate the first computing device of the first user, and a second content region displaying one or more of the second user media stream depicting the second user and the second workspace media stream depicting the second physical activity scene that is proximate the second computing device of the second user. The method also includes providing the graphical virtual meeting user interface for display.

Implementations may include one or more of the following features. The method where the first content region of the graphical user interface depicts the first workspace media stream; and the first workspace media stream depicts a first tangible work created in the first physical activity scene by the first user. The method may include receiving an input via an input device of the first computing device and the graphical user interface, the input virtually annotating the first tangible work with a first annotation. Colon>providing the graphical virtual meeting user interface for display includes providing the graphical virtual meeting user interface for display via a display device of the second computing device of the second user; and the method further may include: updating the first content region to overlay a first graphical annotation element reflecting the first annotation over the first workspace media stream. The method may include: receiving an input via an input device of the first computing device and the graphical user interface, the input instructing to augment a view of the first workspace media stream; and updating the first content region to reflect an augmentation to the view of the first workspace media stream based on the input. The method may include receiving an instruction to switch the first workspace media stream to the second workspace media stream; and updating the first content region of the first graphical user interface to depict the second workspace media stream. The method may include: receiving a request to initiate an asynchronous communication session representing a virtual meeting; determining a set of users; sending a notification to each users of the set of users of the request to initiate the communication session, the set of users including the first user and the second user; and receiving the first media data and the second media data responsive to sending the notification to each of the first user and the second user. Providing the graphical virtual meeting user interface for display further may include: providing a first instance of the graphical virtual meeting user interface for display to the first user via a display of the first computing device; and providing a second instance of the graphical virtual meeting user interface for display to the second user via a display of the second computing device. The method may include initiating a breakout session between the first computing device and the second computing device, the breakout session including a display of the first user media stream, the second user media stream, and an instruction from the second computing device.

One general aspect includes a method also includes receiving a plurality of workspace media streams from a plurality computing devices, each of the workspace media streams depicting a corresponding physical activity scene; generating a plurality of graphical user interface instances; each instance of the plurality of graphical user interface instances depicting one or more workspace media streams from the plurality of workspace media streams received from the plurality of computing devices; and providing the plurality of graphical user interface instances for display via the plurality of computing devices, respectively.

Implementations may include one or more of the following features. The method may include: receiving a selection of a workspace media stream from the plurality of workspace media streams; and causing the selected workspace media stream from the plurality of workspace media streams to be displayed in each of the graphical user interface instances providing for display via the plurality of computing devices. The method may include: initiating a breakout session between a first computing device of the plurality of computing devices and a second computing device of the plurality of computing devices, the breakout session including a display of a workspace media stream from the plurality of workspace media streams, a second workspace media stream from the plurality of workspace media streams, and an instruction from the second computing device. Each graphical user interface instance of the plurality of graphical user interface instances further depicts each of the user media streams.

The virtual classroom system also includes a stand configured to position a first computing device having one or more processors; one or more video capture devices of the first computing device, the one or more video capture devices being configured to capture a first user media stream depicting a first user and a first workspace media stream depicting a first physical activity scene that is proximate the first computing device of the first user; a communication unit configured to receive second media data via a network, the second media data including a second user media stream depicting a second user and a second workspace media stream depicting a second physical activity scene that is proximate a second computing device of the second user; an activity application configured to generate a graphical virtual meeting user interface including: a first content region displaying one or more of the first user media stream depicting the first user and the first workspace media stream depicting the first physical activity scene that is proximate the first computing device of the first user; and a second content region displaying one or more of the second user media stream depicting the second user and the second workspace media stream depicting the second physical activity scene that is proximate the second computing device of the second user. The system also includes a display configured to display the graphical virtual meeting user interface.

Implementations may include one or more of the following features. The virtual classroom system where the first content region of the graphical user interface depicts the first workspace media stream; and the first workspace media stream depicts a first tangible work created in the first physical activity scene by the first user. The virtual classroom system may include: an input device configured to receive an input, the input virtually annotating the first tangible work with a first annotation. The activity application is further configured to update the first content region to overlay a first graphical annotation element reflecting the first annotation over the first workspace media stream. Responsive to receiving the input, the activity application updates the first content region to reflect an augmentation to the view of the first workspace media stream based on the input. The communication unit is further configured to receive a request to initiate a communication session representing a virtual meeting and the activity application is further configured to determine a set of users and cause the communication unit to send a notification to each users of the set of users to initiate the communication session, the set of users including a first user and a second user and the communication unit is configured to receive the first workspace media stream and the second media data responsive to sending the notification to each of the first user and the second user. The communication unit is further configured to send the graphical virtual meeting user interface for display on a second computing device.

Other implementations of one or more of these aspects and other aspects described in this document include corresponding systems, apparatus, and computer programs, configured to perform the actions of the methods, encoded on computer storage devices. The above and other implementations are advantageous in a number of respects as articulated through this document. Moreover, it should be understood that the language used in the present disclosure has been principally selected for readability and instructional purposes, and not to limit the scope of the subject matter disclosed herein.

### BRIEF DESCRIPTION OF THE DRAWINGS

The disclosure is illustrated by way of example, and not by way of limitation in the figures of the accompanying drawings in which like reference numerals are used to refer to similar elements.

FIGS. 1A and 1B illustrates an example system for a virtual classroom session.

FIG. 2 is a block diagram illustrating an example computer system for interactive education using a virtual teaching agent.

FIG. 3 is a block diagram illustrating an example computing device.

FIGS. 4A, 4B, 4C, 4D and 4E illustrate an example graphical user interface for a virtual classroom session.

FIG. 5 is a flowchart of a method of organizing a virtual classroom session.

FIGS. 6A, 6B, 6C and 6D illustrate an example graphical user interface for a virtual classroom.

FIG. 7 illustrates an example graphical user interface for a virtual classroom.

FIG. 8 illustrates an example graphical user interface for a virtual classroom.

### DETAILED DESCRIPTION

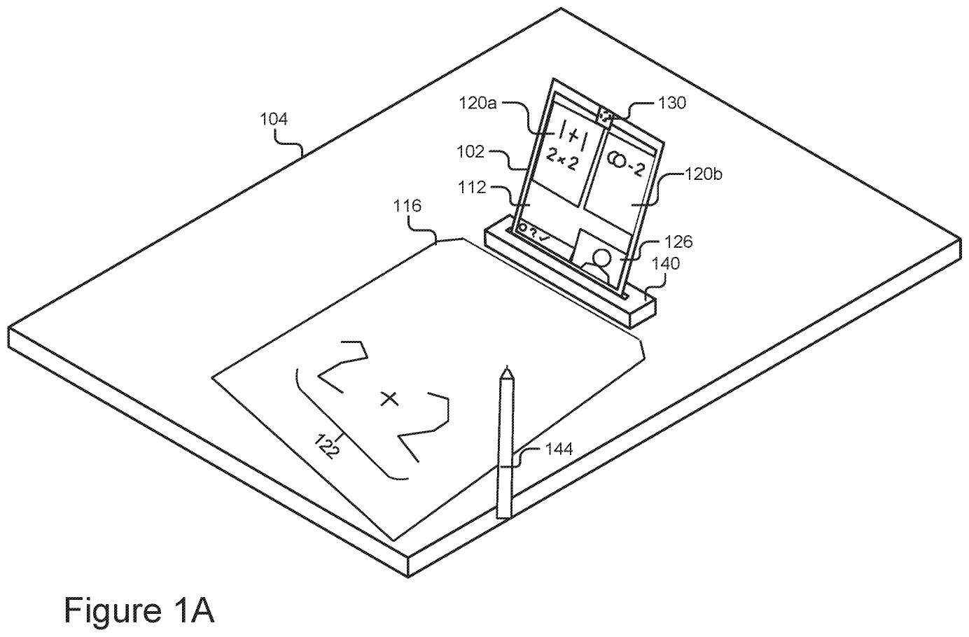

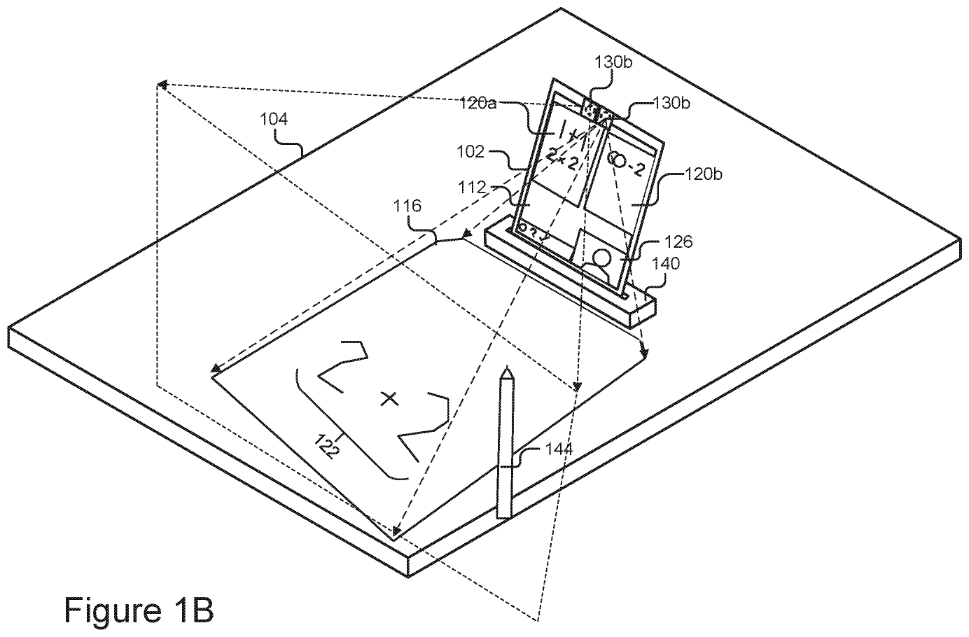

The technology described herein is capable of facilitating a virtual classroom setting. FIG. 1 shows an example of a user participating in a virtual classroom session. As shown in FIG. 1, a user may have a first computing device 102 positioned on a physical surface 104. The computing device may be displaying media data on one or more graphical user interfaces (“GUI”), depicting various media streams, such as a workspace media stream 120b and/or an application stream 120a on a display screen 112 of the computing device 102. The virtual classroom setting may be a web-hosted session where the first user may be able to view this media data in the form of a user media stream 126 depicting another user in the virtual classroom session with multiple other users. Each of the other users may be participating in the virtual classroom session on their own individual computing devices 102 and viewing one or more media streams 120 of various video streams being captured by video capture devices 130 on the various computing devices 102.

As shown in FIG. 1, as the user participates in the virtual classroom session, the user may interact with a physical activity scene 116 proximate to the computing device 102. In some implementations, the computing device 102 may be positioned in a substantially vertical position for viewing of the display 112. The computing device 102 may be positioned by a stand 140 as described in more detail elsewhere herein. As the user interacts on the physical activity surface 116, a video capture device (also referred to as a “camera”) 130 of the computing device 102 may capture a workspace media stream of the physical activity scene 116 that is proximate to the computing device 102.

In some implementations, the user may position various items on/in the physical activity scene 116 for interacting with the virtual classroom session. For example, the user may interact by placing objects, creating tangible works 122, and/or making gestures within the field of view of the video capture device 130. In some implementations, the tangible works 122 may be recognizable by a detector 304 (not shown) and identified after they have been created, drawn, or positioned on the physical activity scene 116. For example, as shown in FIG. 1, an application stream 120a in a portion of the GUI may display a question, such as a math problem “1+1” and the detector 304 may detect the user creating a tangible work 122, such as with a writing implement 144 in order to provide the answer and/or show the work to solve the math problem. The detector 304 may recognize the tangible work 122 and may create a workspace media stream 120b that is generated and displayed on the display 112. In some implementations, a graphical user meeting user interface may be generated that displays a substantially live stream of the workspace media stream 120b of the physical activity scene 116 of the user or another remote user participating in the virtual classroom session.

In some implementations, a user can create one or more tangible works(s) 122 on the physical activity surface 116. The tangible work(s) 122 may be drawn or written, such as with a writing implement 144 or another creating implement. In some implementations, the tangible work(s) 122 may be formed, such as out of clay or connectable objects. The video capture device 130 may be able to capture the process of the user creating the one or more tangible work(s) 122 in a video stream. In some implementations, the detector 304 may be able to detect and/or recognize the creation of the one or more tangible work(s) 122 as described elsewhere herein.

In some implementations, the user can interact with the physical activity surface 116 by making gestures or motions within the field of view of the video capture device 130. For example, a user can tap a finger on a portion of the physical activity surface 116 and the detector 304 can detect the finger tap in the video stream. In another example, the detector 304 may detect a user raising their hand in the field of view of the video capture device 130 and may cause a “hand raised” notification or alert to be sent to another computing device 102 of the virtual classroom session, such as a teacher's computing device 102 as described elsewhere herein.

FIG. 1B shows an example system for a virtual classroom session. As shown in FIG. 1B, multiple video capture devices 130a and 130b are included in the computing device 102. Video capture device 130a is a downward facing camera that has a field of view that includes the physical activity scene 116. Video capture device 130b is a forward-facing camera that captures an area that a user would be positioned in when viewing the display 112. By using both the downward facing camera 130a and the forward-facing camera 130b, the computing device can capture two separate media streams, such as a workspace media stream and a user media stream. In some implementations, these streams can be captured simultaneously and sent to other devices of the system as needed for display. In some implementations, a single video capture device 130 may be used and a user may reposition the camera or adjust the filed of view (such as by removing an adapter) as needed to capture the different media streams as described elsewhere herein.

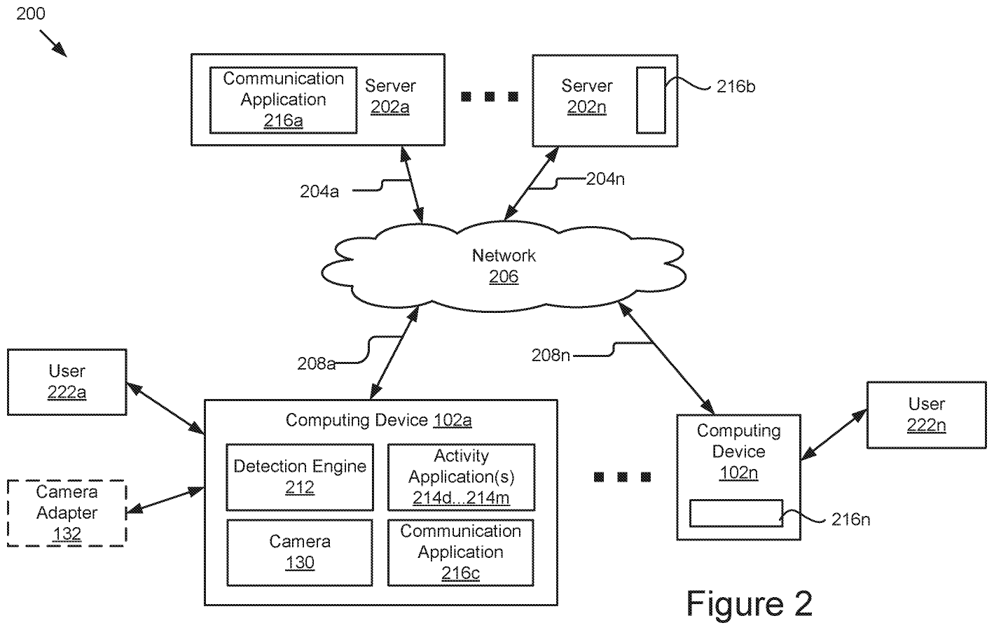

FIG. 2 is a block diagram illustrating an example computer system 200 that can organize a virtual classroom. As depicted, the system 200 may include computing devices 102a . . . 102n and servers 202a . . . 202n communicatively coupled via a network 206. In FIG. 2 and the remaining figures, a letter after a reference number, e.g., “120a”, represents a reference to the element having that particular reference number. A reference number in the text without a following letter, e.g., “120”, represents a general reference to instances of the element bearing that reference number. It should be understood that the system 200 depicted in FIG. 2 is provided by way of example and that the system 200 and/or further systems contemplated by this present disclosure may include additional and/or fewer components, may combine components and/or divide one or more of the components into additional components, etc. For example, the system 200 may include any number of servers 202, computing devices 102, or networks 206. As depicted in FIG. 2, the computing device 102 may be coupled to the network 206 via the signal line 208 and the server 202 may be coupled to the network 206 via the signal line 204. The computing device 102 may be accessed by user 222.

The network 206 may include any number of networks and/or network types. For example, the network 206 may include, but is not limited to, one or more local area networks (LANs), wide area networks (WANs) (e.g., the Internet), virtual private networks (VPNs), mobile (cellular) networks, wireless wide area network (WWANs), WiMAX® networks, Bluetooth® communication networks, peer-to-peer networks, other interconnected data paths across which multiple devices may communicate, various combinations thereof, etc.

The computing device 102 may be a computing device that has data processing and communication capabilities. In some embodiments, the computing device 102 may include a processor (e.g., virtual, physical, etc.), a memory, a power source, a network interface, and/or other software and/or hardware components, such as front and/or rear facing cameras, display screen, graphics processor, wireless transceivers, keyboard, firmware, operating systems, drivers, various physical connection interfaces (e.g., USB, HDMI, etc.). In some embodiments, the computing device 102 may be coupled to and communicate with one another and with other entities of the system 200 via the network 206 using a wireless and/or wired connection. As discussed elsewhere herein, the system 200 may include any number of computing devices 102 and the computing devices 102 may be the same or different types of devices (e.g., tablets, mobile phones, desktop computers, laptop computers, etc.).

As depicted in FIG. 2, the computing device 102 may include the video capture device 130 (e.g., a camera), a detection engine 212, one or more activity applications 214, and one or more communication applications 216. The computing device 102 and/or the video capture device 130 may be equipped with the camera adapter 132 as discussed elsewhere herein. In some embodiments, the camera adapter 132 may include one or more optical elements (e.g., mirrors and/or lenses) to adapt the standard field of view of the video capture device 130 of the computing device 102 to capture substantially and only the activity scene 116 of the physical activity surface 104, although other implementations are also possible and contemplated. To adapt the field of view of the video capture device 130, the mirrors and/or lenses of the camera adapter 132 may be positioned at an angle to redirect and/or modify the light being reflected from the physical activity surface 104 into the video capture device 130. In some embodiments, the camera adapter 132 may include a slot adapted to receive an edge of the computing device 102 and retain (e.g., secure, grip, etc.) the camera adapter 132 on the edge of the computing device 102. In some embodiments, the camera adapter 132 may be positioned over the video capture device 130 to direct the field of view of the video capture device 130 toward the physical activity surface 104.

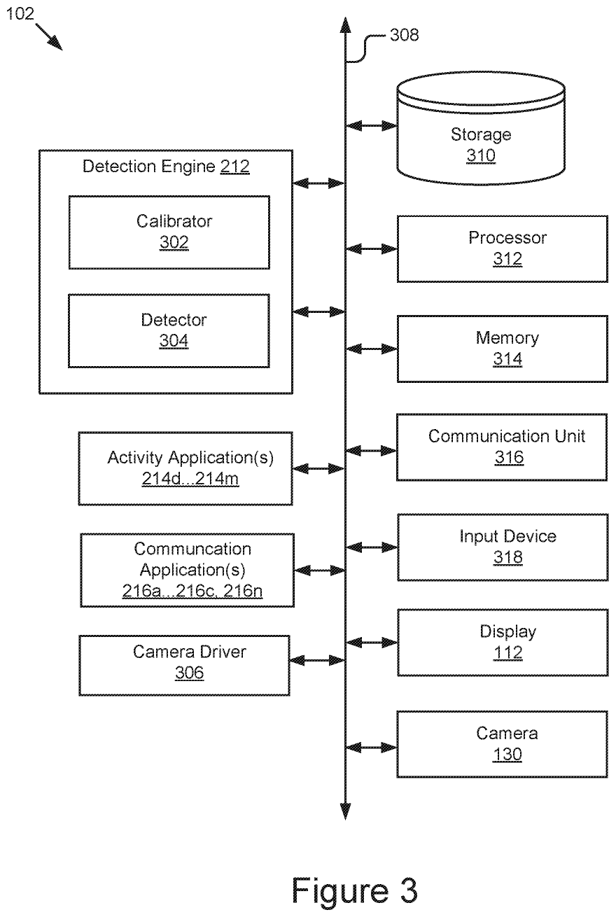

In some embodiments, the detection engine 212 may detect and/or recognize users and/or objects and/or tangible works 122 located in the activity scene 116 of the physical activity surface 104, and cooperate with the activity application(s) 214 to provide the user with a virtual classroom session that includes interactions with various items in the physical activity scene 116. As an example, the detection engine 212 may detect a user writing numbers or letters as tangible works 122 and recognize contours, characters, visual representations, user markings in the tangible works 122, and cooperate with the activity application(s) 214 to provide the user with digital content items that are relevant to the tangible content item of the tangible works 122. In another example, the detection engine 212 may process the video stream captured by the video capture device 130 to detect and recognize a tangible work 122 created by the user on the activity scene 104. The components and operations of the detection engine 212 and the activity application 214 are described in detail with reference to at least FIG. 3.

The server 202 may include one or more computing devices that have data processing, storing, and communication capabilities. In some embodiments, the server 202 may include one or more hardware servers, server arrays, storage devices and/or storage systems, etc. In some embodiments, the server 202 may be a centralized, distributed and/or a cloud-based server. In some embodiments, the server 202 may include one or more virtual servers that operate in a host server environment and access the physical hardware of the host server (e.g., processor, memory, storage, network interfaces, etc.) via an abstraction layer (e.g., a virtual machine manager).

The server 202 may include software applications operable by one or more processors of the server 202 to provide various computing functionalities, services, and/or resources, and to send and receive data to and from the computing devices 102. For example, the software applications may provide the functionalities of internet searching, social networking, web-based email, blogging, micro-blogging, photo management, video/music/multimedia hosting/sharing/distribution, business services, news and media distribution, user account management, video conferencing, or any combination thereof. It should be understood that the server 202 may also provide other network-accessible services.

In some embodiments, the server 202 may include a search engine capable of retrieving results that match one or more search criteria from a data store. As an example, the search criteria may include an image and the search engine may compare the image to product images in its data store (not shown) to identify a product that matches the image. In another example, the detection engine 212 and/or the storage 310 (e.g., see FIG. 3) may request the search engine to provide information that matches a physical drawing, an image, and/or a tangible object extracted from a video stream.

It should be understood that the system 200 illustrated in FIG. 2 is provided by way of example, and that a variety of different system environments and configurations are contemplated and are within the scope of the present disclosure. For example, various functionalities may be moved from a server to a client, or vice versa and some implementations may include additional or fewer computing devices, services, and/or networks, and may implement various client or server-side functionalities. In addition, various entities of the system 200 may be integrated into a single computing device or system or divided into additional computing devices or systems, etc.

FIG. 3 is a block diagram of an example computing device 102. As depicted, the computing device 102 may include a processor 312, a memory 314, a communication unit 316, an input device 318, a display 112, and the video capture device 130 communicatively coupled by a communications bus 308. It should be understood that the computing device 102 is not limited to such and may include other components, including, for example, those discussed with reference to the computing devices 102 in the other Figures.

The processor 312 may execute software instructions by performing various input/output, logical, and/or mathematical operations. The processor 312 may have various computing architectures to process data signals including, for example, a complex instruction set computer (CISC) architecture, a reduced instruction set computer (RISC) architecture, and/or an architecture implementing a combination of instruction sets. The processor 312 may be physical and/or virtual and may include a single core or plurality of processing units and/or cores.

The memory 314 may be a non-transitory computer-readable medium that is configured to store and provide access to data to other components of the computing device 102. In some embodiments, the memory 314 may store instructions and/or data that are executable by the processor 312. For example, the memory 314 may store the detection engine 212, the activity applications 214, and the camera driver 306. The memory 314 may also store other instructions and data, including, for example, an operating system, hardware drivers, other software applications, data, etc. The memory 314 may be coupled to the bus 308 for communication with the processor 312 and other components of the computing device 102.

The communication unit 316 may include one or more interface devices (I/F) for wired and/or wireless connectivity with the network 206 and/or other devices. In some embodiments, the communication unit 316 may include transceivers for sending and receiving wireless signals. For example, the communication unit 316 may include radio transceivers for communication with the network 206 and for communication with nearby devices using close-proximity connectivity (e.g., Bluetooth®, NFC, etc.). In some embodiments, the communication unit 316 may include ports for wired connectivity with other devices. For example, the communication unit 316 may include a CAT-5 interface, Thunderbolt™ interface, FireWire™ interface, USB interface, etc.

The display 112 may display electronic images and data output by the computing device 102 for presentation to the user 222. The display 112 may include any display device, monitor or screen, including, for example, an organic light-emitting diode (OLED) display, a liquid crystal display (LCD), etc. In some embodiments, the display 112 may be a touch-screen display capable of receiving input from one or more fingers of the user 222. For example, the display 112 may be a capacitive touch-screen display capable of detecting and interpreting multiple points of contact with the display surface. In some embodiments, the computing device 102 may include a graphic adapter (not shown) for rendering and outputting the images and data for presentation on display 320. The graphic adapter may be a separate processing device including a separate processor and memory (not shown) or may be integrated with the processor 312 and memory 314. In some implementations, the graphics adapter, and the display screen 112 may be configured to display one or more GUIs in portions of the display screen 112 that can present various information to the user 222.

The input device 318 may include any device for inputting information into the computing device 102. In some embodiments, the input device 318 may include one or more peripheral devices. For example, the input device 318 may include a keyboard (e.g., a QWERTY keyboard), a pointing device (e.g., a mouse or touchpad), a microphone, a camera, etc. In some implementations, the input device 318 may include a touch-screen display capable of receiving input from the one or more fingers of the user 222. In some embodiments, the functionality of the input device 318 and the display 320 may be integrated, and the user 222 may interact with the computing device 102 by contacting a surface of the display 320 using one or more fingers. For example, the user 222 may interact with an emulated keyboard (e.g., soft keyboard or virtual keyboard) displayed on the touch-screen display 320 by contacting the display 320 in the keyboard regions using his or her fingers.

The detection engine 212 may include a calibrator 302 and a detector 304. The components 212, 302, and 304 may be communicatively coupled to one another and/or to other components 214, 216, 306, 310, 312, 314, 316, 318, 112, and/or 130 of the computing device 102 by the bus 308 and/or the processor 312. In some embodiments, the components 212, 302, and 304 may be sets of instructions executable by the processor 312 to provide their functionality. In some embodiments, the components 212, 302, and 304 may be stored in the memory 314 of the computing device 102 and may be accessible and executable by the processor 312 to provide their functionality. In any of the foregoing implementations, these components 212, 302, and 304 may be adapted for cooperation and communication with the processor 312 and other components of the computing device 102.

The calibrator 302 includes software and/or logic for performing image calibration on the video stream captured by the video capture device 130. In some embodiments, to perform the image calibration, the calibrator 302 may calibrate the images in the video stream to adapt to the capture position of the video capture device 130, which may be dependent on the configuration of the stand 140 on which the computing device 102 is situated. When the computing device 102 is placed into the stand 140, the stand 140 may position the video capture device 130 of the computing device 102 at a camera height relative to the physical activity surface and a tilt angle relative to a horizontal line. Capturing the video stream from this camera position may cause distortion effects on the video stream. Therefore, the calibrator 302 may adjust one or more operation parameters of the video capture device 130 to compensate for these distortion effects. In other implementations, the calibrator 302 may be configured to flip any images that may be captured upside down in the activity scene 116 so that when they are presented on the computing device 102, they appear to be oriented correctly. Examples of the operation parameters being adjusted include, but are not limited to, focus, exposure, white balance, aperture, f-stop, image compression, ISO, depth of field, noise reduction, focal length, etc. Performing image calibration on the video stream is advantageous, because it can optimize the images of the video stream to accurately detect the objects depicted therein, and thus the operations of the activity applications 214 based on the objects detected in the video stream can be significantly improved.

In some embodiments, the calibrator 302 may also calibrate the images to compensate for the characteristics of the activity surface (e.g., size, angle, topography, etc.). For example, the calibrator 302 may perform the image calibration to account for the discontinuities and/or the non-uniformities of the activity surface, thereby enabling accurate detection of objects on the activity surface when the stand 140 and the computing device 102 are set up on various activity surfaces (e.g., bumpy surface, beds, tables, whiteboards, etc.). In some embodiments, the calibrator 302 may calibrate the images to compensate for optical effect caused by the camera adapter 132 and/or the optical elements of the video capture device 130. In some embodiments, the calibrator 302 may also calibrate the video capture device 130 to split its field of view into multiple portions with the user being included in one portion of the field of view and the activity surface being included in another portion of the field of view of the video capture device 130.

In some embodiments, different types of computing device 102 may use different types of video capture device 130 that have different camera specifications. For example, the tablets made by Apple may use a different type of video capture device 130 from the tablets made by Amazon. In some embodiments, the calibrator 302 may use the camera information specific to the video capture device 130 of the computing device 102 to calibrate the video stream captured by the video capture device 130 (e.g., focal length, distance between the video capture device 130 to the bottom edge of the computing device 102, etc.). The calibrator 302 may also use the camera position at which the video capture device 130 is located to perform the image calibration.

The detector 304 includes software and/or logic for processing the video stream captured by the video capture device 130 to detect the various interactions on the physical activity scene 116 and/or users 222 present in the activity surface in the video stream. In some embodiments, to detect an object in the video stream, the detector 304 may analyze the images of the video stream to determine line segments, and determine the object that has the contour matching the line segments using the object data in the storage 310. In some embodiments, the detector 304 may provide the tangible objects detected in the video stream to the activity applications 214. In some embodiments, the detector 304 may store the tangible objects detected in the video stream in the storage 310 for retrieval by other components. In some embodiments, the detector 304 may determine whether the line segments and/or the object associated with the line segments can be identified in the video stream and instruct the calibrator 302 to calibrate the images of the video stream accordingly.

The activity application 214 includes software and/or logic executable on the computing device 102. In some embodiments, the activity application 214 may receive various video streams from other computing devices 102 and may display various activities in the virtual classroom setting based on the video streams and or interactions on the physical activity scene 116. Non-limiting examples of the activity application 214 include learning applications, video games, assistive applications, storyboard applications, collaborative applications, productivity applications, etc. Other types of activity application are also possible and contemplated.

The communication application 216 includes software and/or logic executable on the computing device 102. In some embodiments, the communication application 216 may send and receive various media streams from other computing devices 102 and may facilitate the display of those media streams, such as one or more user media streams and/or one or more workspace media streams on various computing device 102. In some implementations, the communication application 216 may facilitate the virtual classroom session by displaying various received media streams to the user of the computing device 102 and sending various captured media streams to the other computing devices 102. Other types of communication applications 216 are also possible and contemplated.

The camera driver 306 includes software storable in the memory 314 and operable by the processor 312 to control/operate the video capture device 130. For example, the camera driver 306 may be a software driver executable by the processor 312 for instructing the video capture device 130 to capture and provide a video stream and/or a still image, etc. In some embodiments, the camera driver 306 may be capable of controlling various features of the video capture device 130 (e.g., flash, aperture, exposure, focal length, etc.). In some embodiments, the camera driver 306 may be communicatively coupled to the video capture device 130 and other components of the computing device 102 via the bus 308, and these components may interface with the camera driver 306 to capture video and/or still images using the video capture device 130.

As discussed elsewhere herein, the video capture device 130 (also referred to herein as a camera) is a video capture device adapted to capture video streams and/or images of the physical activity surface. In some embodiments, the video capture device 130 may be coupled to the bus 308 for communication and interaction with the other components of the computing device 102. In some embodiments, the video capture device 130 may include a lens for gathering and focusing light, a photo sensor including pixel regions for capturing the focused light, and a processor for generating image data based on signals provided by the pixel regions. The photo sensor may be any type of photo sensor (e.g., a charge-coupled device (CCD), a complementary metal-oxide-semiconductor (CMOS) sensor, a hybrid CCD/CMOS device, etc.). In some embodiments, the video capture device 130 may include a microphone for capturing sound and/or voice input from the user. Alternatively, the video capture device 130 may be coupled to a microphone coupled to the bus 308 or included in another component of the computing device 102. In some embodiments, the video capture device 130 may also include a flash, a zoom lens, and/or other features. In some embodiments, the processor of the video capture device 130 may store video and/or still image data in the memory 314 and/or provide the video and/or still image data to other components of the computing device 102, such as the detection engine 212 and/or the activity applications 214. In some embodiments, the computing device 102 may have multiple video capture device(s) 130 and each of those video capture device(s) 130 may have different fields-of-view, such as a downward facing, front facing, rear facing, side facing, split views, panoramic views, fish eye views, up facing views, etc.

The storage 310 is a non-transitory storage medium that stores and provides access to various types of data. Non-limiting examples of the data stored in the storage 310 include video stream and/or still images captured by the video capture device 130, various calibration profiles associated with each camera position of the video capture device 130, object data describing various tangible objects, gestures, motions, profiles, etc. In some embodiments, the storage 310 may be included in the memory 314 or another storage device coupled to the bus 308. In some embodiments, the storage 310 may be or included in a distributed data store, such as a cloud-based computing and/or data storage system. In some embodiments, the storage 310 may include a database management system (DBMS). The DBMS may be a structured query language (SQL) DBMS. For example, the storage 310 may store data in an object-based data store or multi-dimensional tables including rows and columns, and may manipulate (i.e., insert, query, update, and/or delete) data entries stored in the storage 310 using programmatic operations (e.g., SQL queries and statements or a similar database manipulation library). Other implementations of the storage 310 with additional characteristics, structures, acts, and functionalities are also possible and contemplated.

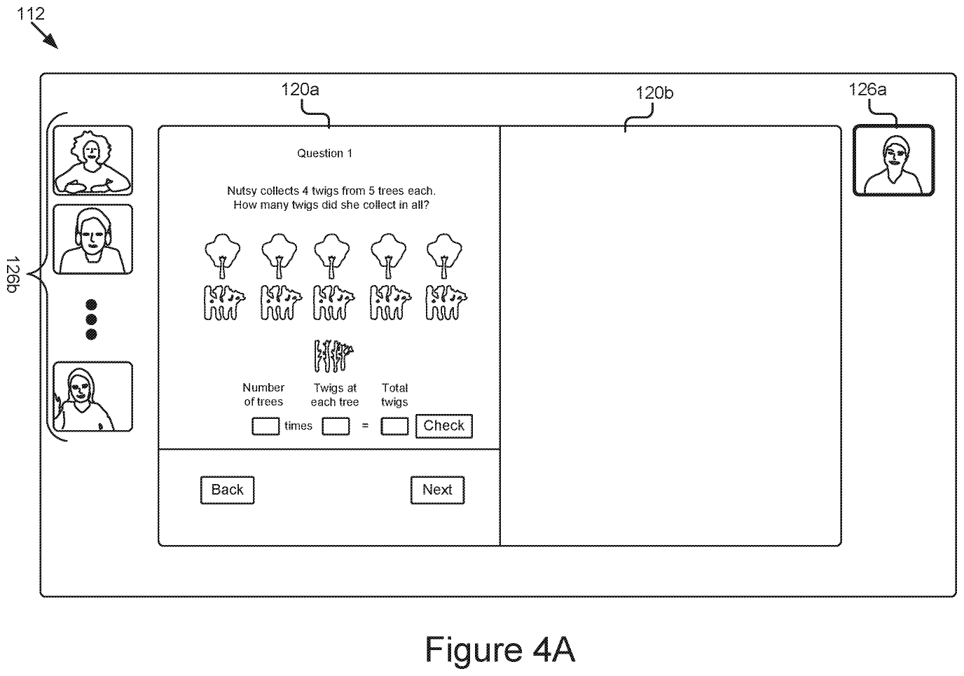

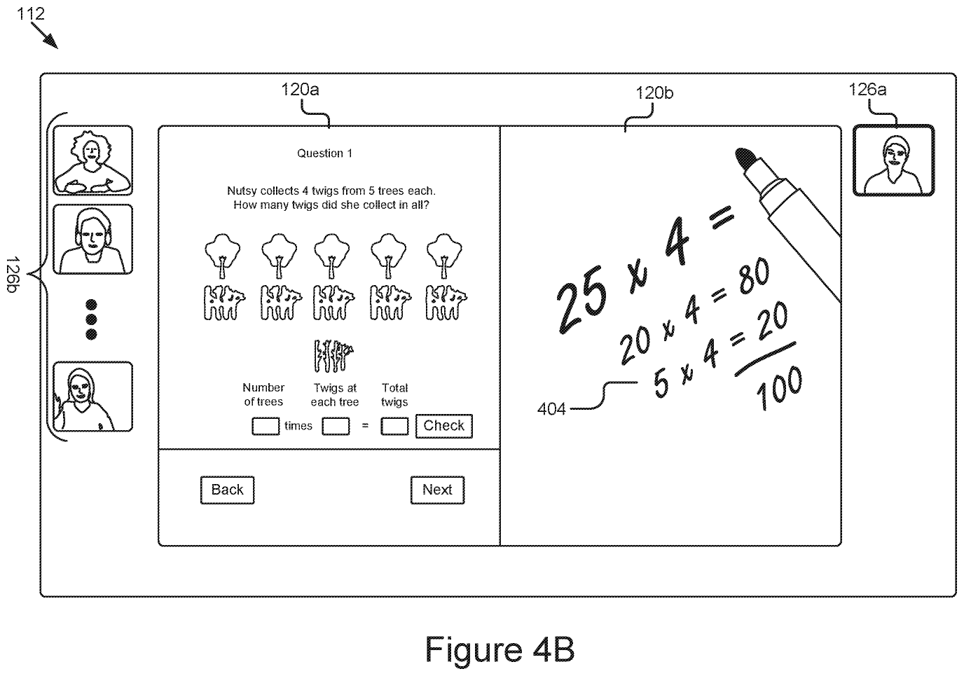

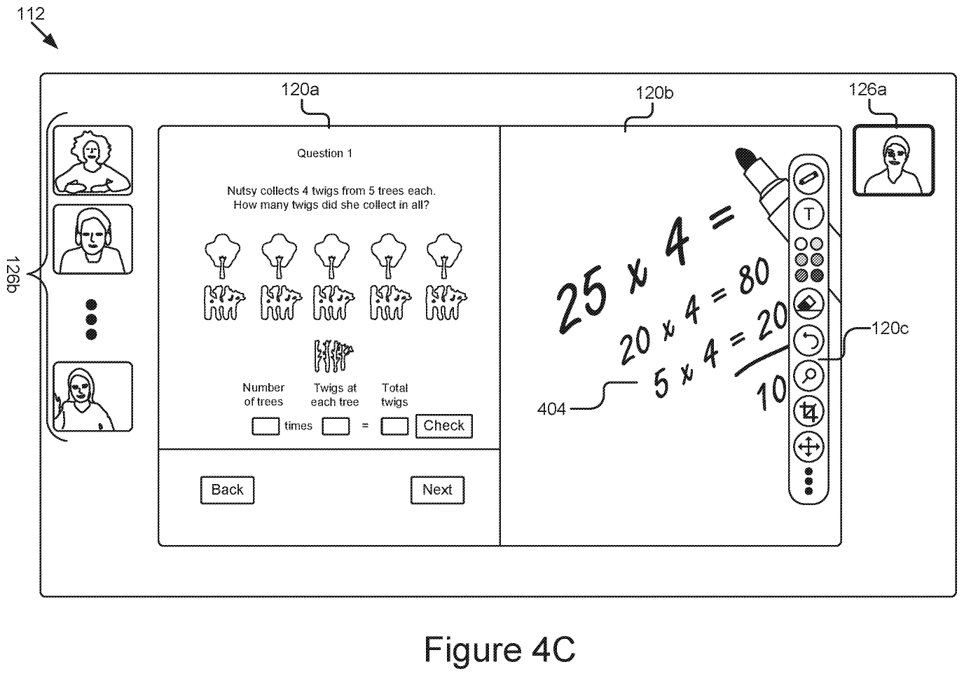

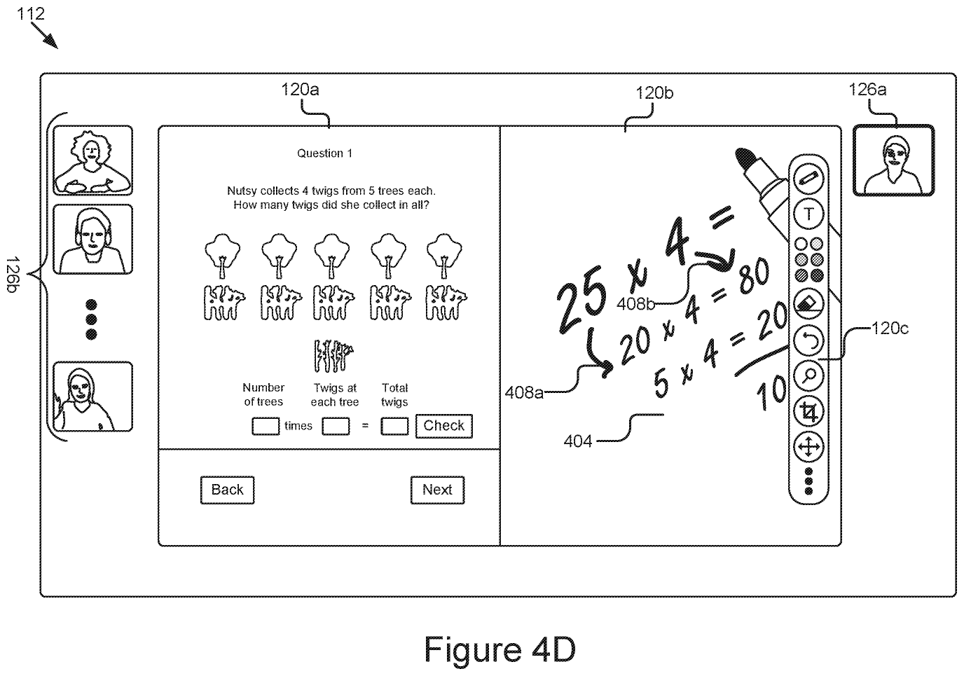

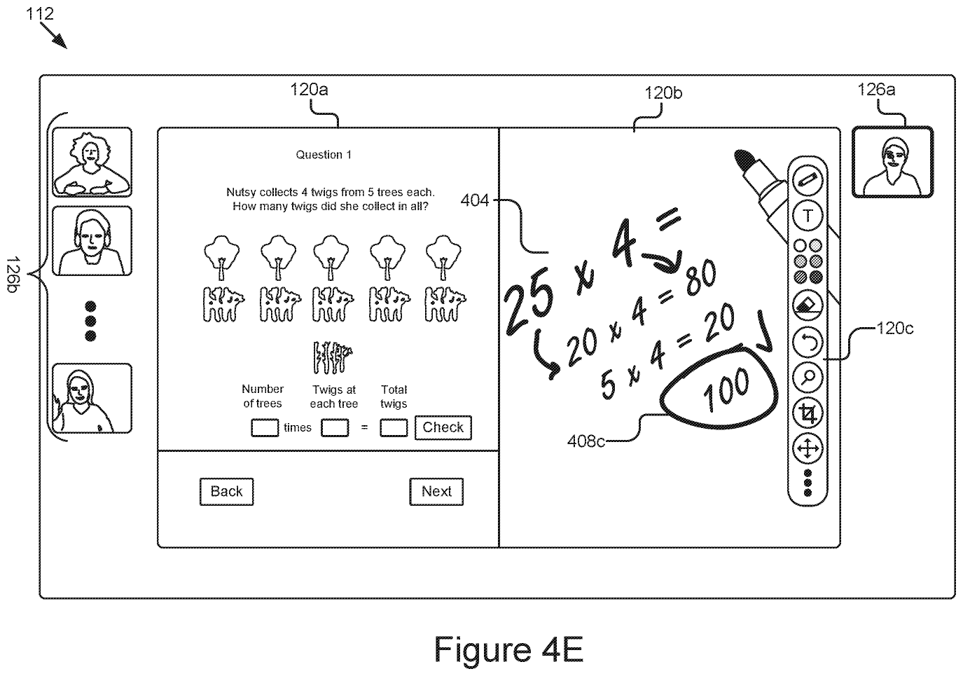

FIGS. 4A-4E are example graphical user interfaces for a virtual classroom session. As shown in FIG. 4A, the display 112 may be for a first user depicted in the user media stream 126a, such as a teacher. Additional users may have user media streams 126b displaying various user media streams 126b of the other users. The display 112 depicts a graphical virtual meeting user interface that includes a first content region that displays the user media stream 126a, in this example a teacher. In another portion of the graphical virtual meeting user interface, a content region may display a workspace media stream 120b of the physical activity scene 116 of the user depicted in the user media stream 126b. In another portion of the graphical virtual meeting user interface, an application stream 120a may display various application prompts. As shown in the example in FIG. 4A, the application prompt is a request for the users to solve a math problem by counting the number of trees times the number of twigs at each tree to get a total twigs number.

FIG. 4B depicts content 404 being displayed in the workspace media stream 120b. The content 404 corresponds to what the user depicted in the user media stream 126a is creating on their physical activity scene 116. In this example, the teacher is working through how to solve the prompt in the application stream 120a and the other users shown in the other user media streams 126b are able to follow along as the teacher creates the solution by viewing the content 404 as it appears in the workspace media stream 120b. In some implementations, during the creation of the workspace media stream, the teacher can perform additional gestures or point to various aspects of the content 404 to draw attention to those portions or mark portions of the video for later reference, such as by double tapping on the physical activity scene 116 to create a bookmark in the video stream of the virtual classroom session.

FIG. 4C depicts an interaction panel 120c that appears as another content region of the graphical virtual meeting user interface. In some implementations, the interaction panel 120c appears only to the user of the computing device 102, while in further implementations, all the participants in the virtual classroom session can view the interaction panel. The interaction panel 120c provides various tools for annotating and/or displaying the content 404 in the workspace media stream 120b. These various tools can include among other things: a pen tool, a highlighting tool, a text tool, various pen color selections, an eraser tool, an undo tool, a zoom tool, a crop tool, and/or a pan tool.

FIG. 4D depicts a selection of the pen tool from the interaction panel 120c and annotations 408a and 408b are created by the user on the content 404 shown in the workspace media stream 120b. The annotations may be displayed on the workspace media streams of computing devices 102 of other users and may help to highlight or comment on the content 404 displayed in the workspace media stream 120b. The annotations 408 mimic an in-person classroom experience with a teacher writing information on a chalkboard, while still allowing all the users to be remote and participate in the virtual classroom session.

FIG. 4E depicts a pan of the content 404 displayed in the workspace media stream 120b. As shown, a user may select the pan tool and may slide the content 404 to the left to add another annotation 408c around the content 404. Using the pan, crop, and/or zoom tools. Users can explore a variety of content 404 on the workspace media stream 120b and can move back up to view previous portions of content 404 that are no longer displayed or zoom in to highlight a specific piece of content 404 to the other users.

In some implementations, a user operating as a teacher may have more controls over the virtual classroom session than another user in the role of a student. For example, an administrative user, such as a teacher, etc., can then manage a teacher specific generated virtual meeting user interface and the students can then interact with a student specific generated virtual meeting user interface. The teacher specific generated virtual meeting user interface may provide additional functionality and control compared to a student specific generated virtual meeting user interface. In some implementations, the student specific generated virtual meeting user interface may be uniform and each student views a similar user interface template. In some implementations, each student may view a personalized student specific generated virtual meeting user interface that may be setup for each student by the teacher, the student, and/or another user, such as a teaching assistant, parent, etc.

In the virtual classroom session, the teacher can present content in the workspace media stream for the students to view on their own computing devices 102. For example, the student user interface may include a content area portion that shows what is present on the workspace media stream that the teacher is sharing, such as a presentation, book, worksheet, assignment, that the teacher is sharing for the student to view. In some implementations, the student may also view a second content area of the generated virtual meeting user interface that shows a user media stream 126 of the teacher, such as with a forward-facing video capture device or other capture device that is pointed towards the teacher. Using these two portions of the user interface, the user media stream 126 and the workspace media stream 120b, a student can view what the teacher is presenting and simultaneously view a substantially live-stream of the teacher. This recreates a setting where the teacher is presenting content, such as on a digital projector with students in a live classroom setting, while allowing the students to be remote and view this on their own individual computing devices 102.

In some implementations, the interaction panel 120c may also include interactable icons that represent different virtual functions that a student can engage in like what a student may do in a live classroom setting. In some implementations, the interaction panel 120c on a student's user interface may include an interactable icon that represents raising a hand and when a student has a question, they can press that hand raising icon. This would cause a hand-raising alert to appear, like if a student had raised their hand. In some implementations, the hand raising icon may be a hand pop-up icon that appears only on the teacher user interface, in some implementations, the hand pop-up icon may be preserved on the teacher user interface until the teacher interacts with the hand pop-up icon, such as by hovering over it, clicking on it, etc. In some implementations, the teacher computing device 102 may capture the audio of the teacher, such as the teacher talking and may detect when a teacher says “Student, I see you raised your hand” and then will clear the pop-up without requiring the teacher to digitally interact with the hand pop-up icon. This would allow the teacher to be notified of questions when a student has them, without being able to view video streams of the students and as the student's questions are addressed, the teacher can clear the pop-up icons. In some implementations, the hand pop-up icon may appear on both the teacher user interface and one or more other student user interfaces to reflect to some or all the users participating in the classroom session that a user has a question.

In some implementations, one or more of the computing devices 102 may include a video capture device 130 that is directed towards a user in front of the computing device, such as a forward-facing camera. The user can opt-in to use this forward-facing camera to capture a video stream of at least a portion of themselves that can be shared to the other users. In this implementation, the detector 304 of the computing device may detect gestures performed by the user, such as raising a hand an expression of confusion and cause the hand pop-up icon to appear on the teacher user interface without having the student press the interactable hand icon. In some implementations the forward-facing video capture device may capture different gestures to perform other actions, such as a quantity of fingers and/or items a user holds up to answer a question from the teacher, etc.

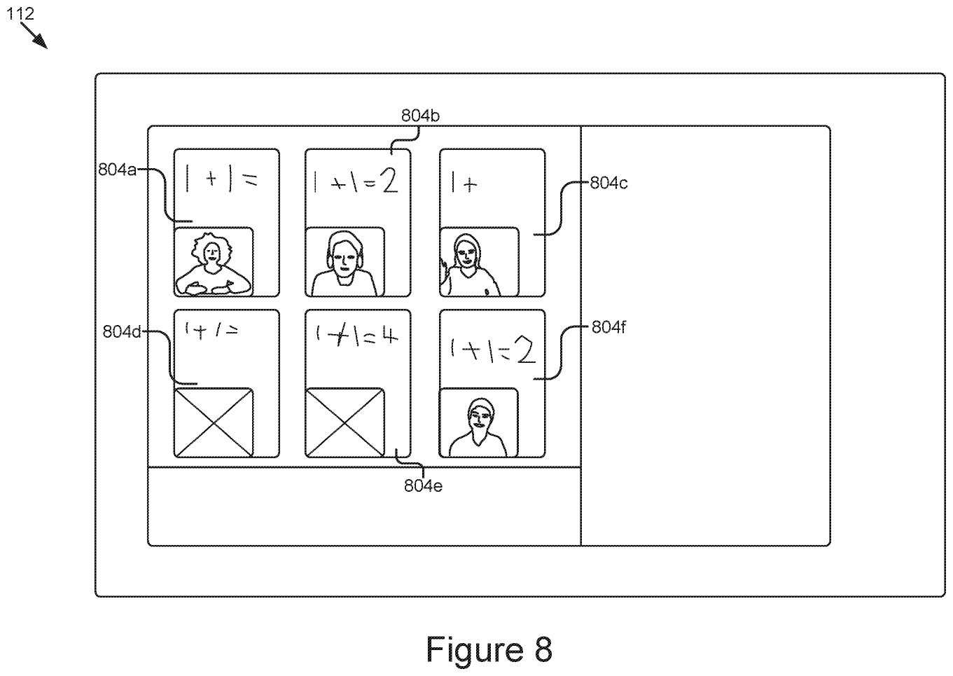

In some implementations, the student may also be able to use a video capture device 130 to capture an activity surface 116 in front of them and share their workspace media stream 120b to the teacher and/or other students a video stream of their activity surface 116. For example, a teacher can write a math problem or display a math problem, such as “What is 10+10=?”. Then the teacher can have each of the students solve the problem on their individual physical activity surfaces 116. As the students write down their answer, they can share their workspace media stream 120b, such as by sending in an image of their activity surface to the interaction panel for others and/or the teacher to view on their computing devices. In further implementations, the teacher graphical virtual meeting user interface may be able to display to the teacher video streams of the student's workspace media streams 120b, as shown in FIG. 8, which allows the teacher to view in substantially real time each of the students activity surfaces as they write down and solve the problem.

In some implementations, the teacher may be able to interact with specific students while they solve the problem, such as by initiating a breakout session, such as a private chat or private video stream between the teacher and student to provide additional instruction. In some implementations, these breakout sessions may be communication sessions representing a virtual meeting. For example, if the teacher observes the student struggling to solve “10+10” the teacher can initiate a video stream that shows their workspace media stream 120b and their audio/video feed directly to the student and provide guidance to that student without interrupting the other student's in the classroom session. In some implementations, one or more teaching assistants may also be available to initiate the one-on-one sessions with students while the teacher continues to present and/or monitor the classroom session. These one-on-one sessions can happen through the student user interface and teacher user interface without requiring the student to navigate out of the classroom session.

In some implementations, the communication session may include determining a set of users from the plurality of users of the virtual classroom session and sending a notification to each of the users in that set of users to initiate the communication session. The communication session may then receive media data, which may include user media streams 126 and/or workspace media streams 120b, from one or more of the set of users in the communication session.

In some implementations, the interaction panel 120c may also allow the teacher to launch other activities for students to engage in. For example, the teacher can populate a quiz in the interaction panel 120c that a student can select an answer to. In some implementations, the answers to the quiz may show up as items in the chat box, while in further implementations, the answers to the quiz may be collected and shown to the teacher or the totals for the quiz may be displayed to everyone. For example, a teacher may put up a multiple-choice quiz question and the interaction panel 120c may display an interactable graphic of the quiz question for each student to select an answer. As students select answers or once all have finished their selection, the quiz panel may display how many of each of the answers were selected. In other implementations, the teacher may display a survey in the interaction panel 120c, and the students may select different answer to the survey. In further implementations, the survey or quiz may merely be a question and students may populate answers using the chat function. The quiz or survey may collect the answers from the chat function and present the results in the interaction panel. This allows the teacher to present open-ended questions and quickly aggregate all the answers from the students. For example, the teacher can ask “How many sides are there on a triangle” and then the chat function can aggregate the answers to show the teacher who provided the correct answer and who may need additional help.

In some implementations, the teacher user interface may have more administrative control, for example, the teacher can view the attendance of the classroom session and may be able to view individual feeds from each student that are not displayed to the entire classroom session. The teacher user interface may also include the interaction panel 120c so that the teacher can prepare and launch quizzes or other options without interrupting the classroom session or disrupting a presentation being displayed on their screen for the students to view.

In some implementations, the video capture device 130 of each computing device 102 may allow the students to quickly submit items for review by the teacher. For example, the teacher may ask each student to write a paragraph about a book they have been reading. The students may write that paragraph on a sheet of paper in the field of view of their video capture device on their computing device. The detector 304 may be able to identify the work 122 being created by the user, such as the paragraph in response to the teacher. Once the student has finished the task requested by the teacher, the activity application 214 of the students computing device may automatically submit the completed task for the teacher to review as a workspace media stream 120b. This submitted task may be in the form of an image depicting the paragraph for the teacher to read or a video file captured over a period of time showing the student in the process of writing the paragraph. In some implementations, automatic image processing may be performed, such as to flip the capture image or video stream, upscale the image and/or video stream to reduce the effects of distortion, mask certain items detected in the image and/or video stream to preserve user privacy, etc. This provides a seamless way for students to quickly perform tasks and provide completed responses that are sent to a specific place on the teacher's computing device for viewing and avoids current issues of submitting tasks where tangible documents have to be scanned and uploaded using a computing device and then saved in a correct format and sent to a teacher. This streamlined process from task request to completion keeps the student engaged and immersed in the virtual session.

In some implementations, the classroom session may facilitate access from a variety of different computing devices 102. For example, some of the users joining the classroom session may have computing devices 102 capable of capturing video streams of activity surfaces, while other computing devices 102 may not include video capture devices 130. The classroom session may be able to adapt for the different device connections and allow only certain students to have increased functionality, such as sharing video streams of activity scenes, without reducing the interaction experience of the other students.

In some implementations, the activity application 214 may include a reward function where users are rewarded for good behavior. The activity application 214 may be able identify actions from the video stream that should be rewarded and provide digital points, game progression, positive reinforcement messages, etc. The good behavior may include answering questions and surveys, providing correct answers, exhibiting positive or attentive gestures captured by a forward-facing camera, arriving to the classroom session on time, not providing disruptive chat, etc. In further implementations, the activity application 214 may be able to mask and/or provide negative reinforcement when bad behavior is detected. For example, if a student is spamming chat, the activity application 214 may automatically disable the chat function for a period of time, if the student is making distracting gestures or motions on the forward-facing video stream, then the activity application 214 may disable or mute the disruptive video stream. In further implementations, the activity application 214 may be able to automatically alert a teacher assistant that can privately work with the student to stop the bad behavior without disrupting the classroom session or removing the student from the classroom session etc.

In some implementations, the teacher user interface may allow the teacher to divide the classroom session up into groups where the groups are automatically paired together to work on a task within the user interface of the classroom session. In the group sessions, each student may be able to share their workspace media stream 120b to the others and the students can interact with each other to complete projects or tasks. The group sessions can be merged back into the large classroom session by the teacher as needed and the teacher can monitor the streams of the individual classroom sessions. This allows the classroom session to mimic live group activities in a live classroom setting, while all the users are remote, which improves learning and engagement among the remote users.

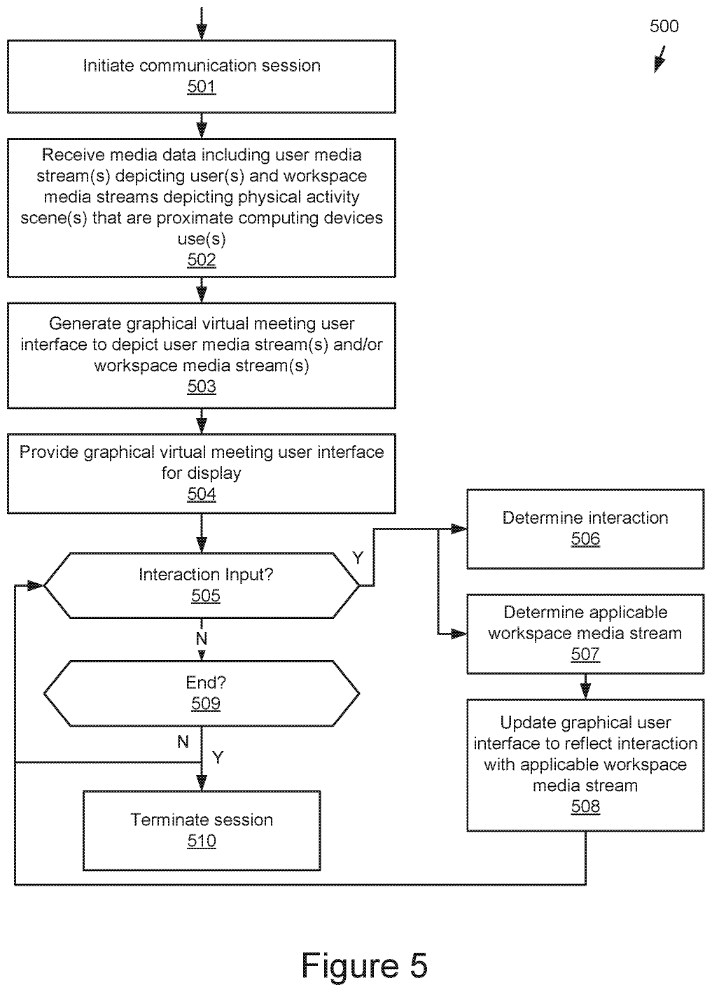

FIG. 5 is a flowchart 500 of an example method of a communication session reflecting a virtual meeting, such as a virtual classroom session, that includes shared tangible workspaces. At block 501, the communication engine 216 may initiate a communication session between two or more endpoints, such as a first computing device 102a and a second computing device 102n. It should be understood that any suitable number of endpoints may be included in the communication session. The communication session may be initiated responsive to receiving a request from a user. For instance, a first user 222a may provide an input via a graphical user interface displayed by the communication application 216c on a first user device, such as computing device 102a, and the communication application 216c may generate and send a communication session initiation request to the communication application 216a. In some implementations, these communication sessions can be between multiple computing devices 102 that may all be joining the communication session together. In some implementations, the communication session can be an asynchronous communication session. In some implementations, a second communication session can be started with members from a first communication session, such as when launching a breakout session or one-on-one meeting between a teacher and student, etc.

The communication application 216a may query the request, a data store included in the server 202a, and/or another suitable data source, for information related to the communication session, such as the users to be included in the communication session. Responsive to determining the information, which may include determining the set of users to be included in, invited to and/or notified of the communication session, such as determining an electronic address of each of the users (e.g., an email address, a device identifier or address, another electronic address or handle, etc., and/or the subject matter to be incorporated into the meeting (e.g., digital curriculum for a class, etc.), the communication application 216a may send a notification to one or more other users, such as a second user, of the request by the first user to initiate the communication session. In further examples, a standing meeting may be calendared, information about which may be stored in a meeting database and in association with the relevant users. The communication application 216a may monitor the standing meetings and automatically initiate the meeting by electronically notifying the users (e.g., by push notification, text message, in-app message, email, or any other suitable mechanism). In this example, the set of users includes the first user and a second user remotely located in a separate location from the first user and the second user may be electronically notified of communication session.

The users, responsive to receiving the communication session request, may accept the request by selecting a corresponding graphical user interface element for doing so (not depicted), in response to which the instance of the communication application executing on their computing device may transmit an electronic acceptance/response to the request, generate and present a graphical virtual meeting user interface via a display of each participating user's computing device, and initiate the capture of the physical activity scene via one or more image sensors associated with the user's computing device. Uniquely, the user's computing device may, in some non-limiting embodiments, include a first image sensor (such as camera 130) configured to capture a facial region of the user and include a second image sensor configured to capture a physical activity scene 116, which may include a physical activity surface 104 such as a table or desktop, on/in which the user may create works as discussed elsewhere herein. Other variations are also possible where just an image sensor (such as the camera 130) may capture the physical activity scene 116, or where additional image sensors (such as camera 130) capture other perspectives, which may be streamed to other users in associate with the communication session environment.

At block 502, the communication application 216 may receive media data from the endpoints participating in the communication session. In some embodiments, a server-side instance of the communication application 216 may receive a plurality of workspace media streams from a plurality of computing devices. Each of the workspace media streams may depict a corresponding physical activity scene 116. In some embodiments, a mix of media streams may be received, some of which may include workspace media streams and some of which may include user media streams depicting at least a facial region of the user. In some embodiments, media data including a workspace media stream and a user media stream may be received from a computing device of each user. Other variations are also possible and contemplated.

Responsive to receiving the media streams, in some embodiments, the communication application, such as a server-side instance thereof (e.g., 214a), may process, combine, encode/decode/transcode, and/or otherwise process and/or optimize the media streams and then transmit a combined media stream to the computing device of each participating user. In further embodiments, a peer-to-peer network or a hybrid of a centralized and peer-to-peer network may be used in which some media data is centrally managed by a server-side instance of the communication application 216, and some media data is transmitted more directly between computing devices and managed locally by a local instance of the communication application, such as instances 216c and 216n, for example. Other suitable variations are possible and contemplated.

In a further example, the communication application 216 may receive a first media data may including a first user media stream depicting a first user and a first workspace media stream depicting a first physical activity scene that is proximate to the first computing device 102 of the first user; a second media data including a second user media stream depicting a second user and a second workspace media stream depicting a second physical activity surface that is proximate to a second computing device 102 of the second user; and so forth (e.g., a third media stream associated with a third user, an nth media stream associated with an nth user, etc.).

At block 503, the communication application 216 may generating a plurality of graphical user interface instances, which may be presented to the corresponding participants so they can engage in the communication session and/or their workspaces can be shared with other participants. For instance, each instance of the plurality of graphical user interface instances may depict one or more workspace media streams from the plurality of workspace media streams received from the plurality of computing devices. Additionally, or alternatively, in some embodiments, some or all of the media data may comprise user media streams and/or workspace media streams. In some cases, a user may wish to mute either their workspace media stream or the user media stream, and the communication application 216 may stop transmitting the muted streams for display to other users, and the graphical user interface instances may be updated to mute the streams, such as discontinue the display of corresponding content regions in the graphical user interface, greying or blacking out of those regions, updating those content regions to display placeholder content, such as a profile picture or other content, or using other suitable mechanisms.

In furtherance of the above example, the communication application 216 may generate a graphical virtual meeting user interface including a first content region displaying one or more of the first user media stream depicting the first user and the first workspace media stream depicting the first physical activity scene that is proximate to the first computing device of the first user. The graphical virtual meeting user interface may also include a second content region displaying one or more of the second user media stream depicting the second user and second workspace media stream depicting the second physical activity scene that is proximate the second computing device of the second user, and any other participating users as the case may be.

At 504, the communication application 216 may provide a graphical virtual meeting user interface for display. In some implementations, the graphical virtual meeting user interface may be displayed on one or more of the computing devices 102. In some implementations, the graphical virtual meeting user interface may be different for various user, for example, an administrative or teacher graphical virtual meeting user interface may be generated for some of the users and a student graphical virtual meeting user interface for other users in the communication session. In some implementations, the graphical virtual meeting user interface may depict one or more of the workspace media stream, the application stream, and/or the user interface stream. In some implementations, the graphical virtual meeting user interface may include one or more content regions where the various streams may be located.

In some implementations, the graphical virtual meeting user interface may be annotated by one or more of the computing devices 102 of the communication session. The annotations may be a graphical annotation element that overlays a media stream and can be displayed on other graphical virtual meeting user interfaces. In some implementations, one or more of the content regions may be augmented, to change the view, layout, size, shape, or other feature of the content region that is displaying a media stream. In some implementations, the augmenting of a content region may be an instruction from a separate computing device 102, while in further implementations, the instruction may come from the computing device 102 on which the content region is displayed.

In some implementations, instructions may be received at one or more of the computing devices 102 to switch a first workspace media stream to a second workspace media stream. These instructions cause the communication application 216 to update the content region of the first workspace media stream to depict the second workspace media stream. These instructions to switch the media stream may derive from the computing device 102 on which the media stream is displayed, or another computing devices of the communication session may send the instructions.

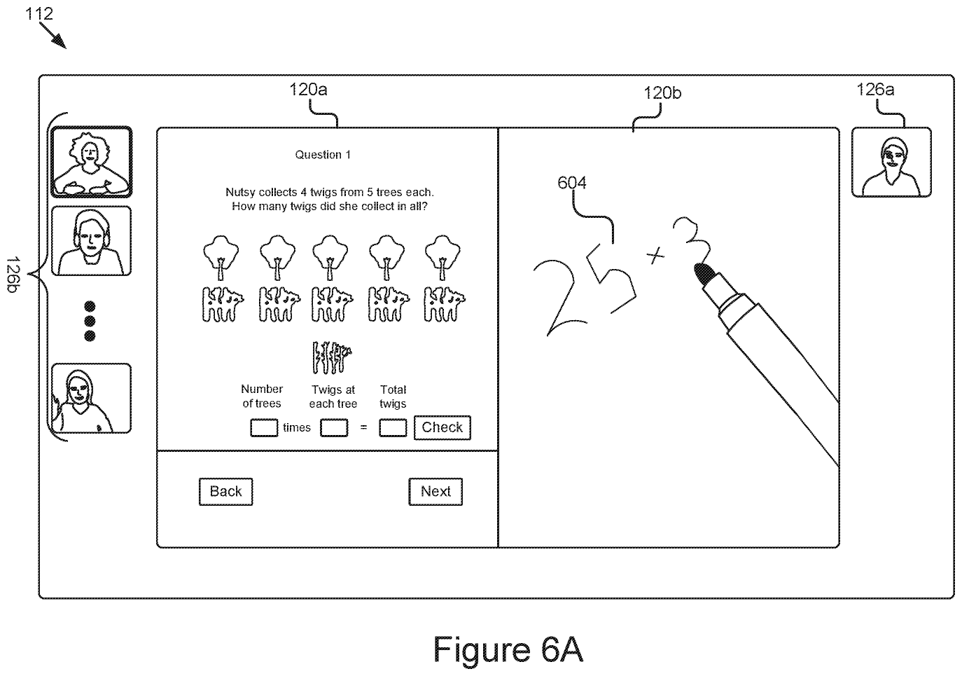

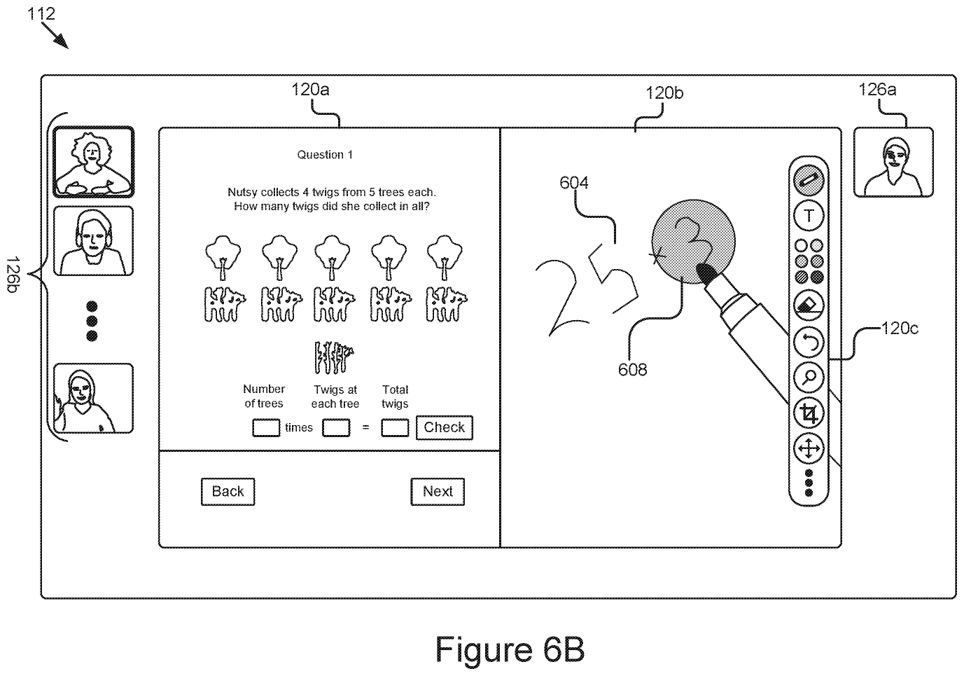

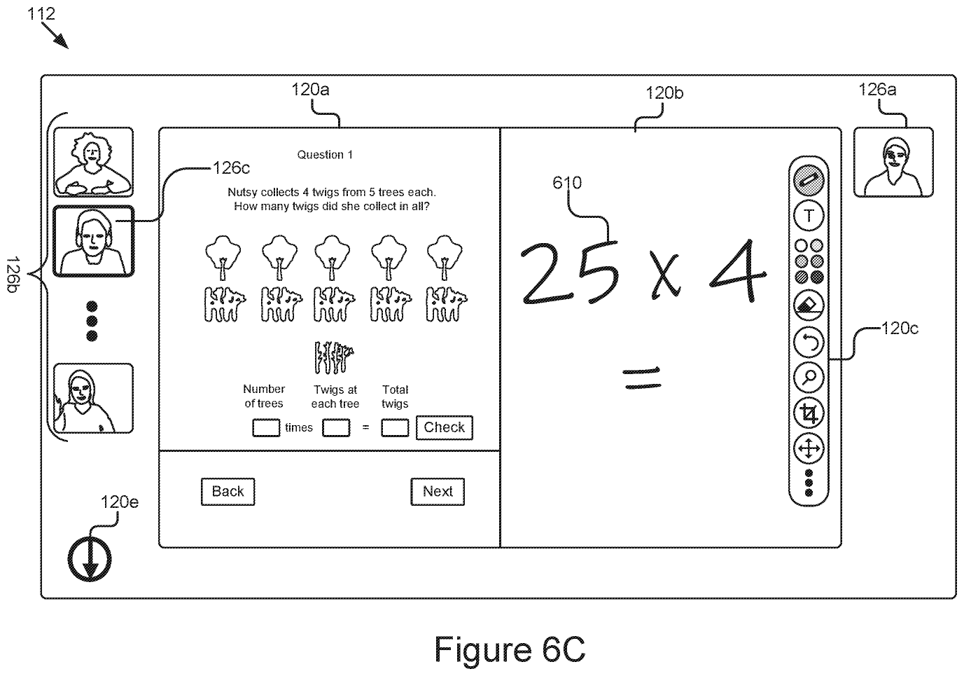

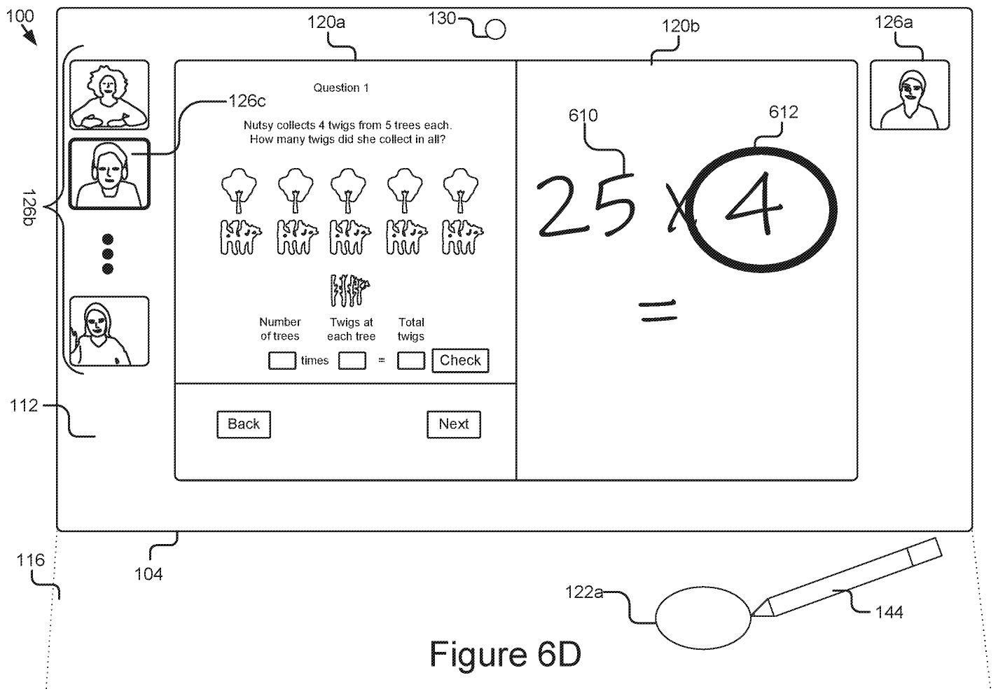

FIG. 6A-6C are an example of a student graphical virtual meeting user interface on a display 112. As shown in FIG. 6A, a student depicted in the user media stream 126a is participating in a virtual classroom session with other users depicted by the other user media streams 126b. The student can view the application stream 120a and the question prompts displayed in the content stream 120a in a first content area of the graphical virtual meeting user interface. The student's workspace media stream 120b is displayed in a second content area and is capturing the tangible work created by the user on the physical activity scene and displaying that tangible work as content 604. In FIG. 6B, a teacher or other student that is participating the virtual classroom session can annotate 608 to overlay a graphical annotation element over the workspace media stream 120b of the student. As shown, the student wrote a “3” on the physical activity scene 116 and the prompt wanted students to write a “4”. The teacher as they observe the workspace media stream 120b of this student is able to use the interaction panel 120c to annotate 608 the graphical element to call attention to the mistake and assist the student, even though the student and teacher are remote.

In FIG. 6C, a teacher or other student that is participating in the virtual classroom selects a transition icon 120e that causes the workspace media stream 120b to switch to another user. As shown in FIG. 6C, the icon is highlighting the user media stream 126c to indicate that a new user's workspace media stream 120b is being displayed and the content 610 is what is being created by the user depicted in the user media stream 126c. A user can interact with the transition icon 120e, or other methods of selecting different users, such as tapping on user media streams in order to cause instructions to be sent to the communication application 216 to switch the workspace media stream 120b from a first workspace media stream to a second workspace media stream.

In FIG. 6D, the physical activity scene 116, the computing device 102, and the display presenting the graphical virtual meeting user interface is shown. In this example, a teacher or other user depicted in the user media stream 126a is viewing the workspace media stream 120b of the user depicted in the user media stream 126c. The teacher can create a tangible work 122a on the physical activity surface 116, such as by using a writing implement 144. In this example, the tangible work 122a in this example is a circle although it could comprise any suitable work created by the user. As the teacher creates the tangible work 122a, the camera 130 captures the creation and causes a corresponding annotation 612 to be displayed overlaid on the workspace media stream 120b. In some implementations, this annotation 612 is part of the teacher's workspace media stream and the two media streams are overlaid to create the workspace media stream 120b as shown in the example. In other implementations, a graphical element is generated based on the tangible work 122 and the graphical element is overlaid onto the student's workspace media stream 120b for display in the graphical virtual meeting user interface. It should be understood that in some embodiments annotations can occur either directly on the display, such as by using the interaction panel 120c or the annotations can be created on the physical activity scene 116 and overlaid or placed onto the workplace media stream 120b for other users of the communication session to view. Other variations are also possible and contemplated.

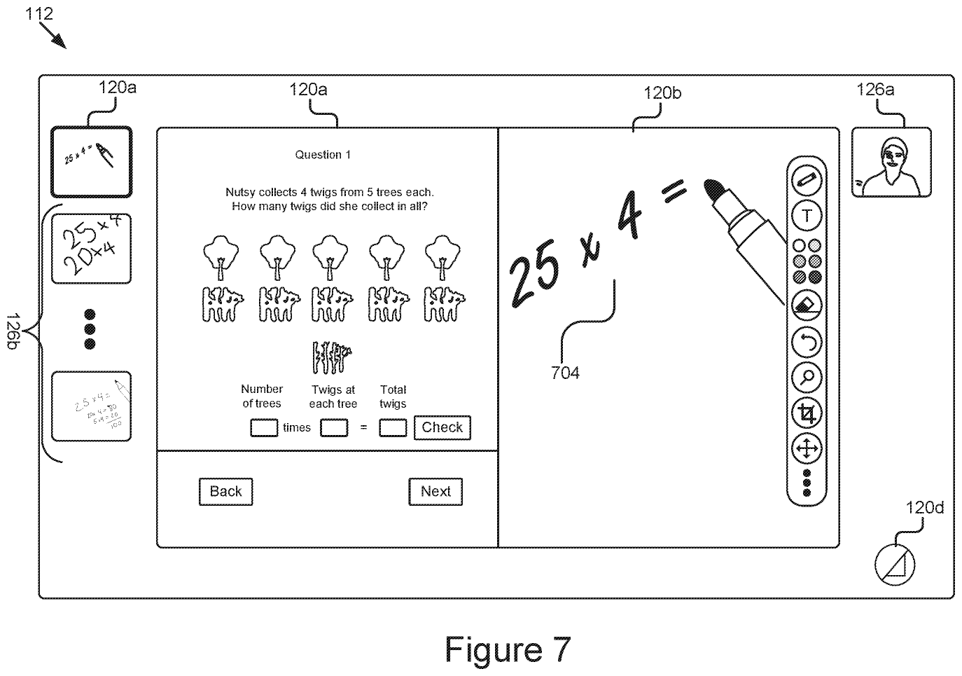

FIG. 7 is an example of a teacher graphical virtual meeting user interface on a display 112. In this example, a teacher is able to select a toggle button 120d on a portion of the graphical virtual meeting user interface and cause the user media streams 126b to display the workspace media streams of the corresponding students instead of the live feeds of the student from the front facing camera. By selecting the toggle button 120d, the teacher can simultaneously view multiple student's workspace media streams. The teacher is able to then interact with various students as needed, such as by praising students as they finish and knowing when to move on, or initiating breakout sessions with students that are struggling with the problem and need additional assistance, such as by using annotations, or additional explanations. The teacher can toggle back and forth between the user media streams and the workplace media streams to both view the faces of the students and the physical activity surfaces 116 of the students as they learn.

FIG. 8 is another example of a teacher graphical virtual meeting user interface on a display 112. In this example, a content area of the graphical virtual meeting user interface is displaying a combined stream 804 that includes both the workplace media stream 120b and the user media stream 126 for multiple users. This user interface allows the teacher to view both the faces of the students, and what they are writing on their corresponding physical activity surfaces 116. From this user interface, the teacher can select one or more combine streams 804 to view the workspace media streams of those users in more detail and initiate additional help and/or breakout sessions. In some implementations, the teacher could also display their workspace media stream 120b on another content area of the teacher graphical virtual meeting user interface while also viewing the combined stream 804 of different users. In some implementations, as shown in combined streams 804d and 804e, the user media streams may be blocked or disable due to privacy constraints or the user hasn't opted into sharing their user media stream 126.

It should be understood that the above-described example activities are provided by way of illustration and not limitation and that numerous additional use cases are contemplated and encompassed by the present disclosure. In the above description, for purposes of explanation, numerous specific details are set forth in order to provide a thorough understanding of the present disclosure. However, it should be understood that the technology described herein may be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of a hardware implementation, a software implementation, or implementations containing both hardware and software elements. For instance, the technology may be implemented in software, which includes but is not limited to firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi™) transceivers, Ethernet adapters, and modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats.

Furthermore, the modules, routines, features, attributes, methodologies and other aspects of the disclosure can be implemented as software, hardware, firmware, or any combination of the foregoing. Also, wherever an element, an example of which is a module, of the specification is implemented as software, the element can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment. Accordingly, the disclosure is intended to be illustrative, but not limiting, of the scope of the subject matter set forth in the following claims.

What is claimed is:

1. A method comprising:
receiving first media data including a first user media stream depicting a first user and a first workspace media stream depicting a first physical activity scene that is proximate a first computing device of the first user;
receiving second media data including a second user media stream depicting a second user and a second workspace media stream depicting a second physical activity scene that is proximate a second computing device of the second user;
generating a graphical virtual meeting user interface including:
a first content region displaying one or more of the first user media stream depicting the first user and the first workspace media stream depicting the first physical activity scene that is proximate the first computing device of the first user; and
a second content region displaying one or more of the second user media stream depicting the second user and the second workspace media stream depicting the second physical activity scene that is proximate the second computing device of the second user; and
providing the graphical virtual meeting user interface for display.

2. The method of claim 1, wherein
the first content region of the graphical user interface depicts the first workspace media stream; and
the first workspace media stream depicts a first tangible work created in the first physical activity scene by the first user.

3. The method of claim 2, further comprising:
receiving an input via an input device of the first computing device and the graphical user interface, the input virtually annotating the first tangible work with a first annotation.

4. The method of claim 3, wherein:
providing the graphical virtual meeting user interface for display includes providing the graphical virtual meeting user interface for display via a display device of the second computing device of the second user; and
the method further comprises:
updating the first content region to overlay a first graphical annotation element reflecting the first annotation over the first workspace media stream.

5. The method of claim 2, further comprising:
receiving an input via an input device of the first computing device and the graphical user interface, the input instructing to augment a view of the first workspace media stream; and
updating the first content region to reflect an augmentation to the view of the first workspace media stream based on the input.

6. The method of claim 1, further comprising:
receiving an instruction to switch the first workspace media stream to the second workspace media stream; and
updating the first content region of the first graphical user interface to depict the second workspace media stream.

7. The method of claim 1, further comprising:
receiving a request to initiate a communication session representing a virtual meeting;
determining a set of users;
sending a notification to one or more user of the set of users of the request to initiate the communication session, the set of users including the first user and the second user; and
receiving the first media data and the second media data responsive to sending the notification to each of the first user and the second user.

8. The method of claim 1, wherein providing the graphical virtual meeting user interface for display further comprises:
providing a first instance of the graphical virtual meeting user interface for display to the first user via a display of the first computing device; and
providing a second instance of the graphical virtual meeting user interface for display to the second user via a display of the second computing device.

9. The method of claim 1, further comprising:
initiating a breakout session between the first computing device and the second computing device, the breakout session including a display of the first user media stream, the second user media stream, and an instruction from the second computing device.

10. A method comprising:
receiving a plurality of workspace media streams from a plurality of computing devices, each of the workspace media streams depicting a corresponding physical activity scene;
generating a plurality of graphical user interface instances; each instance of the plurality of graphical user interface instances depicting one or more workspace media streams from the plurality of workspace media streams received from the plurality of computing devices; and
providing the plurality of graphical user interface instances for display via the plurality of computing devices, respectively.

11. The method of claim 10, further comprising:
receiving a selection of a workspace media stream from the plurality of workspace media streams; and
causing the selected workspace media stream from the plurality of workspace media streams to be displayed in each of the graphical user interface instances providing for display via the plurality of computing devices.

12. The method of claim 10, further comprising:
initiating a breakout session between a first computing device of the plurality of computing devices and a second computing device of the plurality of computing devices, the breakout session including a display of a workspace media stream from the plurality of workspace media streams, a second workspace media stream from the plurality of workspace media streams, and an instruction from the second computing device.

13. The method of claim 10, further comprising:
receiving a plurality of user media streams from the plurality computing devices, each of the user media streams depicting a corresponding user, wherein each graphical user interface instance of the plurality of graphical user interface instances further depicts each of the user media streams.

14. A virtual classroom system comprising:
a stand configured to position a first computing device having one or more processors;
one or more video capture devices of the first computing device, the one or more video capture devices being configured to capture a first user media stream depicting a first user and a first workspace media stream depicting a first physical activity scene that is proximate the first computing device of the first user;
a communication unit configured to receive second media data via a network, the second media data including a second user media stream depicting a second user and a second workspace media stream depicting a second physical activity scene that is proximate a second computing device of the second user;
an activity application configured to generate a graphical virtual meeting user interface including:
a first content region displaying one or more of the first user media stream depicting the first user and the first workspace media stream depicting the first physical activity scene that is proximate the first computing device of the first user; and
a second content region displaying one or more of the second user media stream depicting the second user and the second workspace media stream depicting the second physical activity scene that is proximate the second computing device of the second user; and
a display configured to display the graphical virtual meeting user interface.

15. The virtual classroom system of claim 14, wherein
the first content region of the graphical user interface depicts the first workspace media stream; and
the first workspace media stream depicts a first tangible work created in the first physical activity scene by the first user.

16. The virtual classroom system of claim 15, further comprising:
an input device configured to receive an input, the input virtually annotating the first tangible work with a first annotation.

17. The virtual classroom system of claim 16, wherein the activity application is further configured to update the first content region to overlay a first graphical annotation element reflecting the first annotation over the first workspace media stream.

18. The virtual classroom system of claim 14, further comprising:
an input device configured to receive an input, the input instructing to augment a view of the first workspace media stream; and
wherein responsive to receiving the input, the activity application updates the first content region to reflect an augmentation to the view of the first workspace media stream based on the input.

19. The virtual classroom system of claim 14, wherein the communication unit is further configured to receive a request to initiate a communication session representing a virtual meeting and the activity application is further configured to determine a set of users and cause the communication unit to send a notification to each users of the set of users to initiate the communication session, the set of users including a first user and a second user and the communication unit is configured to receive the first workspace media stream and the second media data responsive to sending the notification to each of the first user and the second user.

20. The virtual classroom system of claim 14, wherein the communication unit is further configured to send the graphical virtual meeting user interface for display on a second computing device.
